(19) United States
(12) Patent Application Publication
(10) Pub. No.: US 2010/0003507 A1
(43) Pub. Date: Jan. 7, 2010

(54) Multi-layer polyimide film and method of manufacturing the same

(76) Inventors: Paul S.C. Wu, Hsinchu (TW); Shih-Song Cheng, Hsinchu (TW)

Correspondence Address: MARTINE PENILLA & GENCARELLA, LLP, 710 LAKEWAY DRIVE, SUITE 200, SUNNYVALE, CA, 94085, US

(21) Appl. No.: 12/229,155

(22) Filed: Aug. 19, 2008

(30) Foreign Application Priority Data
Jul. 2, 2008 (TW) 97124863

(51) Int. Cl. B32B 27/00; B32B 9/00

(52) U.S. Cl. 428/336; 428/473.5; 428/332; 264/299

(57) ABSTRACT

This invention relates to a multi-layer polyimide film and a method of manufacturing the same. The multi-layer polyimide film may include a functional filler. The multi-layer polyimide film is manufactured according to the method of this invention. The method includes adding tetracarboxylic acid dianhydride to a diamine solution at an equal mole ratio to form a polyamic acid solution; mixing some of the polyamic acid solution with a functional filler; adding the polyamic acid solution having the functional filler and the polyamic acid solution without the functional filler respectively to mix with aliphatic carboxylic acid anhydride and tertiary amine contained in mixing tanks to form two mixed solutions; supplying the two mixed solutions respectively to at least two reservoirs of a slot die coating device; extruding the two mixed solutions simultaneously from the slot die coating device onto a conveyor belt, then transporting the conveyor belt coated with the two mixed solutions to an oven for heating to form a self-supporting film; and carrying out thermal curing or infrared curing for the self-supporting film to convert remaining amide groups to imide groups completely to form a multi-layer polyimide film.

### BACKGROUND OF THE INVENTION

1. Field of the Invention

The invention relates to multi-layer polyimide films and the method of manufacturing the same, particularly relating to manufacturing multi-layer polyimide films using a chemical conversion process and a slot die coating technique.

2. Description of Related Art

In a conventional method of manufacturing a polyimide (PI) film, polyamic acid is coated on the conveyor belt and carried to the oven for curing to form a polyimide film. The method using a thermal conversion process completely converts the amide group to the imide group. As the method of manufacturing a polyimide film as disclosed in U.S. Pat. No. 7,273,661, the method uses a thermal conversion process for curing to form a polyimide film. However, the thermal conversion process has a very slow conversion rate and consumes a lot of energy. The throughput is then prevented from achieving a higher level by using this type of process in mass production.

The demand for various properties of polyimide films has grown with an expanding electronics industry. Properties such as heat-conducting, electricity-conducting, and surface roughness are all desired functionality for the polyimide film. Therefore, functional fillers are added to the polyamic acid during manufacturing polyimide films. To achieve the desired functionality of the film in practice, the amount of fillers added will be greater than that in theory, and this results in better distribution. However, the amount of fillers added often affects the mechanical properties of the film, such as modulus, elongation rate, tensile strength, and flexibility. For example, carbon black is added to the polyimide film to improve the electrical conductivity of the film. However, if too much carbon black is added, the mechanical properties, such as tensile strength and flexibility, of the film will be deteriorated such that they fail to conform to the industrial standards. This means the polyimide film will not own the acceptable mechanical properties and electrical conductivity simultaneously.

### SUMMARY

The invention relates to multi-layer polyimide films and the method of manufacturing the same, particularly relating to manufacturing multi-layer polyimide films using a chemical conversion process and a slot die coating technique. To counter the disadvantages of manufacturing polyimide films using conventional techniques, disadvantages such as adding functional fillers to the film can adversely affect the mechanical properties of the film and increase processing time, the invention provides a method of manufacturing a multi-layer polyimide film to solve the aforesaid problem.

According to an embodiment of the invention, a method of manufacturing a multi-layer polyimide film is provided. The method includes adding tetracarboxylic acid dianhydride to a diamine solution at an equal mole ratio to form a polyamic acid solution; mixing some of the polyamic acid solution with a functional filler; adding the polyamic acid solution having the functional filler and the polyamic acid solution without the functional filler respectively to mix with aliphatic carboxylic acid anhydride and tertiary amine contained in mixing tanks to form two mixed solutions; supplying the two mixed solutions respectively to at least two reservoirs of a slot die coating device; extruding the two mixed solutions simultaneously from the slot die coating device onto a conveyor belt, then transporting the conveyor belt coated with the two mixed solutions to an oven for heating to form a self-supporting film; and carrying out thermal curing or infrared curing for the self-supporting film to convert remaining amide groups to imide groups completely to form a multi-layer polyimide film.

According to another embodiment of the invention, a multi-layer polyimide film is provided. The multi-layer polyimide film provided includes a central layer, at least one outer layer having a functional filler and being adjacent to the central layer.

In other instances, well known process steps or structures have not been described in detail in order not to unnecessarily obscure the invention. The embodiments of the invention are described below in reference to the accompanied drawings.

### BRIEF DESCRIPTION OF THE DRAWINGS

In the accompanied drawings, like numeral references denote like elements. The accompanied drawings are illustrative but not restrictive; the same applies to the size and ratio of the elements shown in the drawings.

FIG. 1 shows a flow chart of manufacturing a multi-layer polyimide film in accordance with the embodiment of the invention.

FIG. 2 shows a schematic view of a slot die coating device in accordance with the embodiment of the invention.

FIG. 3 shows an enlarged schematic view of the T-shaped die head in FIG. 2 coating a multi-layer polyimide film.

### DETAILED DESCRIPTION OF THE PREFERRED EMBODIMENTS

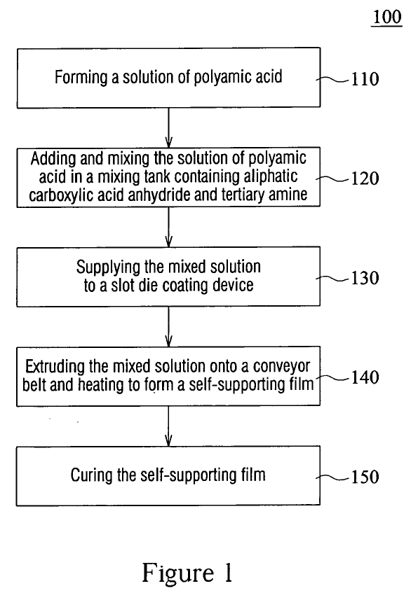

FIG. 1 is a flow chart 100 illustrating a method of manufacturing a multi-layer polyimide film according to one embodiment of the invention. As shown in FIG. 1, the flow chart starts from step 110. In step 110, tetracarboxylic acid dianhydride is first added to a solution containing diamine at an equal mole ratio, where the diamine is pre-dissolved in an aprotic solvent, such as N,N-dimethylacetamide (DMAC). A solution of polyamic acid (PAA) is then formed at a temperature ranging from about 15° C. to about 45° C. In step 120, the polyamic acid solution as above is added and mixed at a low temperature with aliphatic carboxylic acid anhydride and tertiary amine contained in a mixing tank. For example, the aliphatic carboxylic acid anhydride can be acetic anhydride, and the tertiary amine can be pyridine, beta-picoline, or triethylamine. In step 130, the mixed solution in step 120 is supplied to the reservoir of a slot die coating device having at least two slots. In step 140, the slot die coating device extrudes the mixed solution onto a stainless conveyor belt, and then the stainless conveyor belt carrying the mixed solution passes through an oven at a temperature ranging from about 50° C. to about 120° C. for about 5 to 20 minutes to form a self-supporting film having about 25 to 40 weight percent of N,N-dimethylacetamide. In step 150, the self-supporting film is transported to an oven at a temperature ranging from about 150° C. to about 600° C. to carry out thermal curing or infrared curing, so to convert remaining amide groups to imide groups completely.

According to the embodiment of the invention, in step 120 of FIG. 1, the polyamic acid is added and mixed with aliphatic carboxylic acid anhydride and tertiary amine in the mixing tank to carry out a chemical conversion reaction in which some of the polyamic acid groups are converted to imide groups.

This type of chemical conversion reaction has a superior conversion rate to that of conventional thermal conversion reaction. Therefore, a higher throughput can be obtained using the method manufacturing of polyimide according to the embodiment of the invention. In addition, in order to produce multi-layer polyimide films synchronously, the invention adopts a multi-slot die coating device to produce multi-layer polyimide films added with a variety of functional fillers. These functional fillers can include heat-conducting materials, electricity-conducting materials, pigments, metallic powders, or sol-gels. For example, the heat-conducting materials can include boron nitride (BN), titanium diboride (TiB2), or aluminum oxide, and the electricity-conducting materials can include carbon black or copper powder. A film added with electricity-conducting materials can be anti-static and used in electrical conductor application. Furthermore, a film added with metallic powder such as copper can be used as seed layers for electroless plating or electroplating. In addition, to improve the adhesion between electroplating deposition layers, sol-gels can be added to the film to increase the surface roughness or surface area of the film.

In a conventional method of manufacturing polyimide films having functional fillers, the amount of a filler has to be larger than that in theory to improve the distribution of the filler and to achieve the specific function of the filler. However, the film obtained from this method usually exhibits inferior mechanical properties (such as modulus, elongation rate, tensile strength, and flexibility). For example, for a polyimide film of 0.025 mm in thickness, while it can be bent easily to comply with the requirement for a hand-held electronics appliance when it is not added with carbon black, it can be prone to break when bent and hence unable to comply with the requirement for a hand-held electronics appliance when it is added with 30 weight percent of carbon black. For the example above, a sufficient amount of carbon black must be added in the film to attain the desired electrical conductivity. However, the amount of carbon black added deeply affects the mechanical properties of the film. In other words, the more carbon black is added, the inferior the mechanical properties of the film become. Therefore, a polyimide film having simultaneous acceptable mechanical properties and its special function working as desired is hard to come by, and it would be very undesirable in adapting to future micro-sized electronics appliances. Therefore, according to the embodiment of the invention, a polyimide film having simultaneous acceptable mechanical properties and its special function working as desired is obtained by manufacturing multi-layer polyimide films using a multi-slot die coating device.

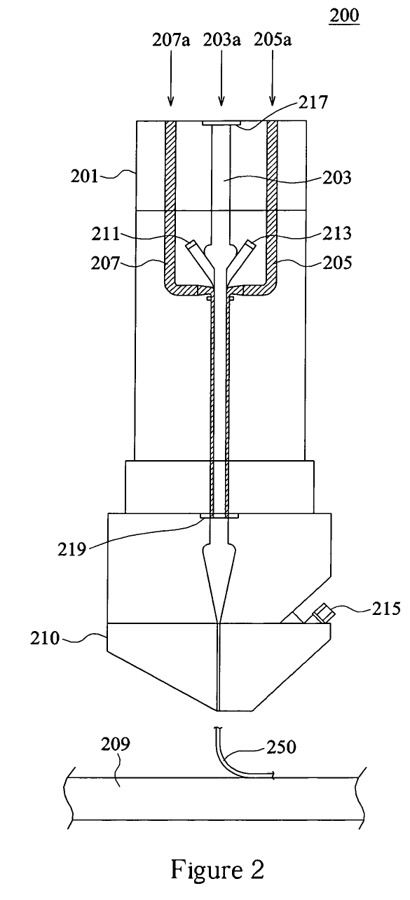

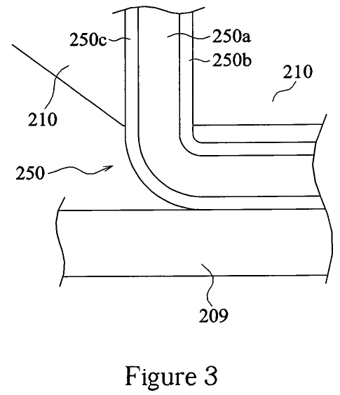

FIG. 2 is a schematic diagram illustrating a slot die coating device 200 according to one embodiment of the invention. FIG. 3 is an enlarged schematic diagram of a T-shaped die head 210 in FIG. 2 coating a multi-layer polyimide film 250. As shown in FIGS. 2 and 3, the slot die coating device 200 includes a three-tier separator 201 and a T-shaped die head 210. The three-tier separator 201 can include a first material duct 203, a second material duct 205, and a third material duct 207. The first material duct 203, the second material duct 205, and the third material duct 207 respectively have a first material inlet 203a, a second material inlet 205a, and a third material inlet 207a. The thicknesses of a second material layer 250b and a third material layer 250c are adjusted by film-thickness adjustors 213 and 211 respectively. A film-thickness adjustor 215 then adjusts the total thickness of the converged three material layers. Through the T-shaped die head 210, a first material layer 250a with the second material layer 250b and the third material layer 250c is extruded onto the stainless conveyor belt 209 to form a polyimide film. Although the figures show only three material ducts, it can be apparent to persons skilled in the art to install more material ducts in the slot die coating device 200.

Additionally, a sealing ring 217 is provided at the opening of the material inlet to prevent material leakage. Moreover, a sealing ring 219 is provided at where the materials converge to prevent material leakage.

To solve the problem of lack of mechanical properties of the conventional film, the polyamic acid solution containing aliphatic carboxylic acid anhydride, tertiary amine, and fillers and the polyamic acid solution containing aliphatic carboxylic acid anhydride and tertiary amine are respectively supplied to their reservoirs (not shown) in the storage tank of the coating device. The polyamic acid without fillers (the first material layer 250a) is coated from the first material duct 203, and the polyamic acid with fillers added (the second material layer 250b and the third material layer 250c) are coated from the second material duct 205 and the third material duct 207, so that a multi-layer polyimide film with acceptable mechanical properties is obtained. The first material layer 250a can have a thickness ranging from about 80 μm to about 100 μm, and the second material layer 250b and the third material layer 250c can each have a thickness ranging from about 1 μm to about 20 μm. However, it is apparent to the persons skilled in the art that the material layer can have any appropriate coating thickness. Since the first material layer 250a does not have a functional filler, its mechanical properties (such as elongation at break) are better than those of the second material layer 250b and the third material layer 250c. Moreover, since functional fillers are only added in the second material layer 250b and the third material layer 250c, the amounts of these functional fillers can be increased to obtain the specific functions (for example, heat-conducting, electricity-conducting, and surface roughness) while the mechanical properties of the film are maintained at an acceptable level. To explain, in contrast to the conventional method of manufacturing polyimide films added with functional fillers, the invention allows the functional fillers to be concentrated in the surface film layer so to decrease the relative amount of polyamic acid used in the surface film layer, and it controls the mechanical properties with the central film layer, which is absent of functional fillers.

In another embodiment of the invention, the polyamic acid with added functional fillers can be coated from the first material duct 203, and the polyamic acid without added functional fillers can be coated from the second material duct 205 and the third material duct 207. According to yet another embodiment of the invention, only the first and the second material ducts 203 and 205 may be used, or only the first and the third material ducts 203 and 207 may be used for coating.

Since the polyamic acid solution has been pre-mixed with aliphatic carboxylic acid anhydride and tertiary amine, the conversion rate may be greatly improved to shorten processing time and increase throughput. Once the polyamic acid is added to aliphatic carboxylic acid anhydride and tertiary amine, a chemical conversion reaction begins. As compared to the conventional method of manufacturing polyimide films, the manufacturing method of the invention can be carried out under a lower temperature. The aliphatic carboxylic acid anhydride can include acetic anhydride, and the tertiary amine can include pyridine, 3-methylpyridine, and triethylamine.

The following are various demonstrating experiments of manufacturing polyimide films according to the invention.

1. A Method of Manufacturing a Single-Layer Polyimide Film with 40% of Carbon Black

Carbon black is added to a pre-formulated polyimide coating solution in which the solid content is 20% and DMAC is 80% where the mole ratio of benzophenonetetracarboxylic dianhydride (BPTA) and 4,4′-diaminodiphenylether (ODA) is 1:1, such that the weight of carbon black is 40% of that of the polyimide matrix (which is the sum of polyimide resin and carbon black). Next, DMAC is added to the polyimide solution so that the final solid content is 17% by weight, then the polyimide solution is kept at a constant temperature of −5° C. Next, 65 g of the cold polyimide solution is added to 4.4 ml of a first mixed solution (acetic anhydride:DMAC=5:1, by weight) and 4.4 ml of a second mixed solution (3-methylpyridine:DMAC=1:1, by weight). Then, the final mixed solution is vigorously stirred for 5 minutes, and is spun in a centrifuge for degassing for 3 minutes. The degassed mixed solution is then coated onto a glass plate using a 900 μm applicator such as a knife, blade, or rod, and is dried by the following steps of: keeping at a constant temperature of 110° C. for 40 minutes; ramping up the temperature to 170° C. in 40 minutes; keeping at a constant temperature of 170° C. for 2 hours; ramping up the temperature to 250° C. in 40 minutes; keeping at a constant temperature of 250° C. for 1 hour; ramping up the temperature to 350° C. in 1 hour; and keeping at a constant temperature of 350° C. for 20 minutes. After the steps, the glass plate is taken out and immersed in cold water to let the polyimide film peel off. The polyimide film is then dried at room temperature thus obtaining a film having a thickness ranging from about 85 μm to about 90 μm.

2. A Method of Manufacturing a Three-Layer Polyimide Film with 40% of Carbon Black

First, 65 g of a polyimide coating solution containing carbon black and having a solid content of 17% as in step 1 above is mixed, stirred, and degassed using the same chemical conversion ratio. A 125 μm applicator such as knife, blade, or rod is used to coat the solution on a glass plate, which is then placed in an oven to dry at 110° C. for 20 minutes. Then the glass plate is taken out to cool to room temperature to form a first film or layer. Next, a polyimide solution without carbon black (having a solid content of 17%) is stirred and degassed using the same chemical conversion ratio. A 600 μm applicator such as knife, blade, or rod is used to coat the solution onto the first layer of the film, which is then placed in an oven to dry at 110° C. for 30 minutes, and is taken out to cool to room temperature to form a second layer on the first layer of the film. Next, 65 g of a polyimide coating solution containing carbon black and having a solid content of 17% is mixed, stirred, and degassed using the same chemical conversion ratio, and is then coated on the second layer of the film using a 125 μm applicator such as knife, blade, or rod. The coated film is placed in an oven to dry by the following steps of: keeping at a constant temperature of 110° C. for 40 minutes; ramping up the temperature to 170° C. in 40 minutes; keeping at a constant temperature of 170° C. for 2 hours; ramping up the temperature to 250° C. in 40 minutes; keeping at a constant temperature of 250° C. for 1 hour; ramping up the temperature to 350° C. in 1 hour; and keeping at a constant temperature of 350° C. for 20 minutes. After the drying process above, the glass plate is taken out to immerse in cold water to let the polyimide film peel off, which is then dried at room temperature, thus obtaining a three-layer composite film having a thickness ranging from about 73 μm to about 75 μm. When the films above are completed, the films in the experiments 1 and 2 and the film without carbon black are compared for their physical properties, as shown in Table 1 below.

TABLE 1

| | Specimen | | |
|---|---|---|---|
| | The polyimide | The polyimide | Polyimide film |
| | film of | film of | without carbon |
| Physical properties | Experiment 1 | Experiment 2 | black |
| Film structure | Single layer | Three layers | Single layer |
| Thickness (μm) | 89~90 | 73~75 | 47~51 |
| Surface resistivity | 10⁵~10⁶ | 10⁵~10⁶ | N/A |
| Modulus (Kgf/mm²) | 51.4~60.5 | 347~365 | 385.8 |
| Breaking stress | 2.2~2.5 | 9.6~10 | 15.92 |
| (Kgf/mm²) | | | |
| Elongation at break | 11~14.7 | 12~18 | 33.9 |
| (%) | | | |
| Flexibility | bad | good | good |

Table 1 may be understood in that the polyimide film of the invention (polyimide film of Experiment 2 of the table) not only has the desired electricity-conducting property, but also maintain some good mechanical properties. Furthermore, during the drying of the single-layer polyimide film with 40% carbon black in Experiment 1, this single-layer polyimide film shows significant contraction strain; whereas during the drying of the three-layer polyimide of the invention, no significant contraction strain can be observed. Therefore, a polyimide film with good physical properties can be manufactured using the method according to the invention. While the invention has been shown and described with reference to a preferred embodiment thereof, and in terms of the illustrative drawings, it should not be considered as limited thereby. Various possible modifications, omissions, and alterations could be conceived of by one skilled in the art to the form and the content of any particular embodiment, without departing from the scope of the invention.

What is claimed is:

1. A method of manufacturing a multi-layer polyimide film, the method comprising:
adding tetracarboxylic acid dianhydride to a diamine solution at an equal mole ratio to form a polyamic acid solution;
mixing some of the polyamic acid solution with a functional filler;
adding the polyamic acid solution having the functional filler and the polyamic acid solution without the functional filler respectively to mix with aliphatic carboxylic acid anhydride and tertiary amine contained in mixing tanks to form two mixed solutions;
supplying the two mixed solutions respectively to at least two reservoirs of a slot die coating device;
extruding the two mixed solutions simultaneously from the slot die coating device onto a conveyor belt, then transporting the conveyor belt coated with the two mixed solutions to an oven for heating to form a self-supporting film; and
carrying out thermal curing or infrared curing for the self-supporting film to convert remaining amide groups to imide groups completely to form a multi-layer polyimide film.

2. The method of claim 1, wherein the slot die coating device is configured to coat at least two layers for a film.

3. The method of claim 1, wherein the diamine solution is formed by pre-dissolving diamine in an aprotic solvent of N,N-dimethylacetamide.

4. The method of claim 1, wherein the aliphatic carboxylic acid anhydride is acetic acid.

5. The method of claim 1, wherein the tertiary amine is pyridine, 3-methylpyridine, or triethylamine.

6. The method of claim 1, wherein the functional filler is a heat-conducting material, an electricity-conducting material, a pigment, a seed layer material for electroless plating or electroplating, or a sol-gel.

7. The method of claim 6, wherein the heat-conducting material is boron nitride, titanium diboride, or aluminum oxide.

8. The method of claim 6, wherein the electricity-conducting material is carbon black or copper powder.

9. A multi-layer polyimide film comprising:
a central layer; and
at least one outer layer having a functional filler and being adjacent to the central layer.

10. The film of claim 9, wherein the central film has a functional filler.

11. The film of claim 9, wherein the functional filler is a heat-conducting material, an electricity-conducting material, a pigment, a seed layer material for electroless plating or electroplating, or a sol-gel.

12. The film of claim 11, wherein the heat-conducting material is boron nitride, titanium diboride, or aluminum oxide.

13. The film of claim 11, wherein the electricity-conducting material is carbon black or copper powder.

14. The film of claim 10, wherein the functional filler is a heat-conducting material, an electricity-conducting material, or a pigment.

15. The film of claim 14, wherein the heat-conducting material is boron nitride, titanium diboride, or aluminum oxide.

16. The film of claim 14, wherein the electricity-conducting material is carbon black or copper powder.

17. The film of claim 9, wherein the central layer has a thickness ranging from about 80 μm to about 100 μm.

18. The film of claim 9, wherein the at least one outer layer has a thickness ranging from about 1 μm to about 20 μm.
